(19) United States
(12) Patent Application Publication
(10) Pub. No.: US 2022/0187444 A1
(43) Pub. Date: Jun. 16, 2022

(54) Safety system and method using a safety system

(71) Applicant: SICK AG, Waldkirch (DE)

(72) Inventor: Holger WAIBEL, Waldkirch (DE)

(21) Appl. No.: 17/550,723

(22) Filed: Dec. 14, 2021

(30) Foreign Application Priority Data
Dec. 16, 2020 (DE) 102020133784.1

(51) Int. Cl. G01S 13/89; G01S 5/02; H04W 4/029

(52) U.S. Cl. CPC G01S 13/89; H04W 4/029; G01S 5/0284; G01S 5/021

(57) ABSTRACT

A method using a safety system for localizing at least one object, having at least one control and evaluation unit, having at least one radio location system, wherein the radio location system has at least three arranged radio stations, wherein at least one mobile device having at least one radio transponder is arranged at the object, wherein position data of the radio transponder and thus position data of the objects can be determined by means of the radio location system, wherein the radio transponder has an identification, wherein a respective radio transponder is associated with at least either a person or a mobile object, wherein the control and evaluation unit is configured to distinguish the persons and mobile objects, and wherein a spatially expanded protected volume is formed around the radio transponder.

The present invention relates to a safety system for localizing at least one object and to a method using a safety system for localizing at least one object.

It is the current practice in industrial safety engineering to manage hazards locally at the hazard site in that an approach or a presence of a person is detected and a machine or travel movement is stopped or the movement is slowed down in a safety relevant manner. The prior art only describes local safety concepts.

Persons should be protected as efficiently as possible from injuries through machines such as robots, presses or autonomous vehicles. The machines should also not mutually damage or destroy one another. Collisions with transported goods on an autonomous vehicles or on vehicles should also be avoided.

An object of the invention is to achieve an optimization between safety and productivity. A required minimum amount of safety is specified, partly by safety standards, partly by tighter guidelines or a higher safety requirement of users. At the same time, productivity of persons and machine should be maximized.

A further object of the invention comprises providing a safety system that does not only provide a local securing option. It should be made possible that all the persons and mobile objects or mobile vehicles, production routines and/or logistic routines are controllable on the basis of position information that is present such that a residual risk for all involved persons can be tolerated and a productivity of a plant and automation routines is optimum.

The object is satisfied by a safety system for localizing at least one object, having at least one control and evaluation unit, having at least one radio location system, wherein the radio location system has at least three arranged radio stations, wherein at least one mobile device having at least one radio transponder is arranged at the object, wherein position data of the radio transponder and thus position data of the objects can be determined by means of the radio location system, wherein the position data can be transmitted from the radio station of the radio location system to the control and evaluation unit and/or the position data can be transmitted from the radio transponder to the control and evaluation unit, wherein the control and evaluation unit is configured to cyclically detect the position data of the radio transponder, wherein the objects are persons or mobile objects, wherein the radio transponder has identification, wherein a respective radio transponder is associated with either a person or a mobile object, wherein the control and evaluation unit is configured to distinguish the persons and mobile objects, and wherein a spatially expanded protected volume is formed around the radio transponder.

The object is furthermore satisfied by a method having a safety system for localizing at least one object, having at least one control and evaluation unit, having at least one radio location system, wherein the radio location system has at least three arranged radio stations, wherein at least one mobile device having at least one radio transponder is arranged at the object, wherein position data of the radio transponder and thus position data of the objects are determined by means of the radio location system, wherein the position data are transmitted from the radio station of the radio location system to the control and evaluation unit and/or the position data are transmitted from the radio transponder to the control and evaluation unit, wherein the control and evaluation unit is configured to cyclically detect the position data of the radio transponders, wherein the objects are persons or mobile objects, wherein the radio transponder has identification, wherein a respective radio transponder is associated with at least either a person or a mobile object, wherein the control and evaluation unit is configured to distinguish the persons and mobile objects, and wherein a spatially expanded protected volume is formed around the radio transponder.

The terms protected volume and protected zone are used as synonymous terms in the following.

The objects are protected over the spatially expanded protected volume. If the object comes too close to a hazard site, this is reported to the object, for example visually, and the object can move away from the hazard site again.

In the case of persons as objects, the person can approach the hazard site on foot, for example, up to a permitted minimum distance. As soon as the person approaches the minimum distance, the person is visually warned, for example. Provision can simultaneously also be made that the hazard site reacts to the approach of the person and reduces the degree of a possible hazard.

In the case of mobile objects that are, for example, autonomously driving vehicles, the mobile object can, for example. approach the hazard site while driving, for example, up to a permitted minimum distance. As soon as the mobile object has approached the minimum distance, the mobile object is warned, for example, by means of a command from the control and evaluation unit. Provision can simultaneously also be made that the hazard site reacts to the approach of the mobile object and reduces the degree of a possible hazard. A plurality of mobile objects can also mutually react, for example by evasive maneuvers and/or braking maneuvers.

The safety system allows a reducing influence to be exerted on the arising of risks in a very forward-looking and early manner with the aid of strategic risk reduction and to avoid hazards without the productivity losses of known situative risk reduction strategies.

A securing is possible over larger zones, that is, for example, of a large number of work stations, of a large number of robots, or, for example, even of whole production facilities, since not only a local presence or approach of persons is detected, but also a position of a large number of persons and mobile objects active in an environment or zone can be detected and can be continuously tracked.

This has the advantage that impending hazards can be discovered very much earlier since the control and evaluation unit or the safety system is simultaneously aware of the positions of a large number of objects and likewise knows their cyclic time progression. Measures to reduce risk that intervene a great deal less invasively in the automation routines and that interfere less with the productivity can thereby be carried out by the safety system.

The previously customary strategy in accordance with the prior art, according to which a machine is shut down or slowed down on the presence of a person in a hazard zone, can admittedly also be provided in accordance with, but it is also possible to avoid a shutting down or a direct slowing down with the present invention since more information on the total situation and on the positions of the objects is present.

The localization of the radio transponders takes place by time of flight measurements of radio signals that are cyclically exchanged between the radio transponders and a plurality of fixed radio stations. This triangulation works very well when the signals are transmitted at a sufficient signal strength and on a straight or direct propagation path.

In accordance with a first alternative of the invention, the signals of a radio transponder are received by a plurality of fixed position radio stations or anchor stations and the basis for the localization is created via a time of flight measurement, e.g. the time of arrival or e.g. the time difference of arrival. The calculation or estimation of the position of a radio transponder then takes place on the control and evaluation unit, for example an RTLS server that is connected to all the radio stations or anchor stations via a wireless or wired data link. This mode of localization is called an RTLS mode.

Alternatively, the position information can, however, also be determined on each radio transponder. In this case, the safety system works in a comparable manner to the GPS navigation system. Each radio transponder receives the signals of the radio stations or anchor stations that are transmitted in a fixed time relationship with one another. A position estimate of the radio transponder can also be carried out here via the different time of flight measurements and the knowledge of the radio station positions or anchor positions. The radio transponder itself calculates its position and can transmit it to the RTLS server as required with the aid of the UWB signal or of other wireless data links.

The position determination in the GPS mode is independent of the position determination in the RTLS mode in different respects:
The calculation does not, for example, take place on a central server, but locally on a radio transponder.
The basis for the position calculation is formed by the determined times of flight of the signals of the fixed position radio stations. Unlike this, the signals of the radio transponders serve for the time of flight calculation in the RTLS mode.
The decision on which subset of the radio station signals present are used for the position calculation is made by the radio transponder on the basis of the determined signal quality and the relative radio station positions. A subset of the transmission signals present is thus used. Conversely, in the RTLS mode, use is made of a subset of the signals received at the different radio stations.

This independence of the position determination can now be used to check the localization. If both modes are operated in parallel., i.e. position data are determined both in the RTLS mode and in the GPS model, a diverse and redundant comparison can then take place for verification in this manner. The requirement is the merging of both pieces of position information on the control and evaluation unit.

The safety system makes possible a strategic risk reduction approach that differs from the known situative risk reduction approach at least in that information is used for the situation evaluation that is determined from a substantially larger spatial zone, for example in the best case the total plant being observed.

Due to the greater range of the input information and the greater forewarning time up to the manifestation of a hazard associated therewith, more far-reaching predictions on the expected development of events can take place and possible hazards can be identified considerably earlier in comparison with known environmental sensors that are only locally restricted.

Measures for risk reduction are provided that enable a de-escalating sequence of measures that develop their effectiveness better due to a longer lead time and that also include the effect on the behavior of the persons involved.

An optimization of a total plant or of part zones takes place by the safety system while taking account of a constraint of a tolerable residual risk as a criterion for a decision.

The risk reduction used here preferably uses the position information of all the objects, that is of all the persons and mobile objects, as a rule mobile vehicles and, for example, associated accuracy information as the input information.

Information on the operating environment such as the knowledge of accessible zones, for example travel paths, and the positions of the hazard sites of the machines are taken into account. by the safety system.

The mobile object, a movable machine, or mobile machine can, for example, be a guideless vehicle, a driverless vehicle or autonomous vehicle, an automated guided vehicle, autonomous mobile robot, an industrial mobile robot, or a robot having movable robot arms. The mobile machine thus has a drive and can be moved in different directions.

The person can, for example, be an operator or a service engineer. The radio transponders are arranged on the clothing or on the equipment of the person, for example. It can here, for example, be a vest to which the radio transponders are firmly fixed. The radio transponders are arranged, for example, at the shoulders and in the chest and back areas. The radio transponders can, however, also be arranged at different locations on the person. Two radio transponders are, for example, arranged on the shoulders of a vest of a person.

In a further development of the invention, a size and/or a shape of the protected volume is configurable via a configuration device, with a wireless communication link being present between the configuration device and the mobile device or the radio transponder and/or radio station.

The size and shape of the protected volume can thus be individually adapted. The required safety standards naturally have to be observed here. The configuration device can be a PC, a portable device, a tablet commuter, a smartphone, or similar.

The wireless communication link can be near field communication, abbreviated to NFC.

The wireless communication link can, however, also be a radio link in accordance with the Bluetooth standard or in accordance with the Bluetooth low energy standard, abbreviated to BLE.

Bluetooth low energy, Bluetooth LE, previously Bluetooth Smart, is a radio technology with which devices can be networked in an environment of approximately 10 meters. In comparison with Bluetooth, BLE has a considerably smaller power consumption and lower costs with a similar communication zone.

In a further development of the invention, the shape of the protected volume is rectangular, parallelepiped-shaped, cylindrical, spherical, oval, or cruciform.

Rectangular, parallelepiped-shaped, or cylindrical protected volumes have the advantage that mobile objects such as autonomous vehicles can, for example, be efficiently surrounded by them since these mobile objects themselves are likewise usually rectangular or parallelepiped-shaped. The protected volume here projects over the outer contour of the mobile object, for example at even distances. However, objects such as persons can also be surrounded by rectangular or parallelepiped-shaped protected volumes.

Spherical or, for example, oval or cylindrical protected volumes have the advantage that objects such as persons, for example, can be efficiently surrounded by them since persons are themselves elongate. The protected volume here projects over the outer contour of the person, for example at even distances. Arms and legs of the person are also simply surrounded by the protected volume due to the spherical shape or oval shape. However, objects such as mobile objects can also be surrounded by rectangular or parallelepiped-shaped protected volumes.

Cruciform protected volumes have the advantage that objects such as persons can, for example, be efficiently surrounded by them since persons with extended arms can approach a cruciform shape. The protected volume here projects over the outer contour of the person, for example at even distances. Arms and legs of the person are also surrounded by the protected volume due to the cruciform shape. However, objects such as mobile objects can also be surrounded by cruciform protected volumes.

In a further development of the invention, at least two radio transponders are provided, with the radio transponders having protected volumes of different sizes.

A plurality of radio transponders are thereby provided from which a user only has to select the suitable one.

A time-consuming reprogramming and technical safety acceptance of protected zones by a trained safety engineer is thereby not necessary.

Turn-key solutions from the manufacturer can be sold to customers that have little or no know-how of their own in the area of safety technology in the respective factory facility to be able to independently adapt the protected zones or safety distances.

The person, that is a worker or a service engineer on site or a safety engineer can simply select the protected zone and thus the safety distance that matches the current activity.

The person can simply increase the safety for critical work by a larger protected zone.

In a further development of the invention, the mobile device having the radio transponder has at least one acceleration sensor and a size and/or a shape of the protected volume can be set in dependence on sensor data of the acceleration sensor. The acceleration sensor is, for example, evaluated directly on the mobile device having the radio transponder or is evaluated by the control and evaluation unit.

It is thereby possible, for example, that the radio transponder is configurable or settable by a simple shaking by hand. The size and/or shape of the protected volume can thus be set by a simple shake, for example. Such a configuration can also be time limited, for example. So that the original protected volume is automatically activated again after a specific time.

It is furthermore also possible to exert influence on a hazard site of a machine via an acceleration movement of the mobile device or of the radio transponder. It is, for example, possible due to the movement of the radio transponder to slow down or to stop a hazardous movement of a machine, for example. A machine can, for example, also be put into a setting mode via the movement of the radio transponder.

The person can inform the radio location system of what type of protected zone he requires. A briefly larger protected zone can simply increase the safety for critical work. The advantage of this is that the person can decide himself and does not have to completely rely on the radio location system.

The person on site or a safety engineer can simply reprogram the protected volumes or the safety distances associated therewith so that they match the current/next activity.

The mobile device having the radio transponder can here also have gyroscopes and/or rotation rate sensors that can be evaluated by the control and evaluation unit.

To ensure a minimum amount of safety, the protected volume can, for example, not be completely shut down by the counter measure or be cut down to a radius of ZERO. It is, however, always possible to increase the protected volume.

In a further development of the invention, the radio transponders are visually distinguishable. Different radio transponders having differently preset protected volumes, for example, have different colors, different markings, and/or different symbols. A person who selects the radio transponders for himself, for another person, or for the application on a mobile object can thereby determine which radio transponder has which protected volume or which protected volumes.

Red radio transponders, for example, have large protected volumes; yellow radio transponders have medium-sized protected volumes; and blue radio transponders or green radio transponders have a smaller or a customary normally sized protected volume. The radio transponders can be intuitively distinguished via such a color marking.

The shape of the protected volume can, for example, be recognized in the symbol on the radio transponder so that the suitable transponder and thus the suitable protected volume is selected with reference to the symbol.

In a further development of the invention, a size and/or a shape of the protected volume of the radio transponder is dependent on the position data of the same radio transponder.

The protected zone is, for example, dependent on the height of the radio transponder. A height over a floor is, for example, determined directly via the radio location. For example, the height can also be checked via an air pressure sensor integrated in the radio transponder or the accuracy of the height input can be improved.

The control and evaluation unit, for example, compares a measured position or height of the person with an environmental map of the facility. The control and evaluation unit can determine the height at which the person is located on the basis, for example, of existing 3D data of the environmental map. The same applies to an object or a mobile object, for example an autonomous vehicle, that moves through a factory facility, in particular through a multistory factory facility.

The protected zone can, for example, be made bigger or smaller when the person is outside a predetermined work zone. E.g. when the person who bears the radio transponder is on a ladder or on a lifting cart or, in another case, works on the ground or even lies flat on the ground.

For example, when a person is at a certain height above the ground, the person does not have to be protected from mobile objects on the ground. The ladder or the lifting cart is instead protected from collisions with mobile objects. The productive operation of fixed position machines such as presses or similar that stand on the ground does not have to be restricted.

A change of the protected zones can thus, for example, be carried out in dependence on a detected height.

The protected zones are therefore not statically, but rather dynamically variable. Safety and/or productivity can thereby be increased.

The person, for example a service engineer on site or a safety engineer, is given a larger or smaller protected zone for work outside the normal activity zone. Safety and productivity are thereby also ensured for such activities.

In a further development of the invention, the size and/or the shape of the protected volume of the radio transponder is dependent on the position data of a different, adjacent radio transponder.

The protected zone is changed, for example, when two radio transponders fall below a specific minimum spacing for a specific time period. For example, when a person approaches a mobile object or when, for example, two mobile objects move toward one another.

For example, the person can also additionally activate a key to change the protected zone. A different additional action can also be provided that results in an agreement of the person to change the protected zone. For example, an agreement key can be provided, with a mobile object only continuing its movement when the button or the agreement key has been actuated.

The control and evaluation unit can, for example, control a path calculation for mobile vehicles, with traveled independent individual routes, for example, being combined into convoy groups to provide space for persons.

In a further development of the invention, the size and/or the shape of the protected volume is changed for a limited time and the previously activated size and/or shape is reestablished after an elapse of the time. The protected volume is, for example, changed for a limited time by a person and/or by the machine. The change could e.g. be carried out by the acceleration sensors or by a button, or by a human-to-human interface having a display and control keys that are integrated in the radio transponder.

In a further development of the invention, the safety system has at least one machine arranged as stationary and having a hazard site of the machine, with the position of the hazard site arranged as stationary being known to the control and evaluation unit, with the machine being able to be influenced in dependence on position data of the radio transponder.

The protected zone can, for example, be changed when a person approaches a machine or works on a machine, for example.

A time component is also taken into account, for example. That is a time staggered procedure on the influencing of the machine to prevent a person from unintentionally stopping a machine when walking past, for example. I.e. the machine is slowed down in a first time interval, for example, and/or a work routine is changed. If the radio transponder is located within a specific distance from the machine for longer than a preset time, the total machine is then stopped and/or put into a setting operation.

Provision could further be made that the person additionally has to actuator a key on the machine or on the radio transponder or that another kind of agreement has to take place by the person to stop the machine and/or to put it into a setting operation.

A special radio transponder is, for example, provided that always stops the total machine on which the service engineer is just working, independently of how large it is. That is also the end of the machine that admittedly would not have to be switched off from a technical safety aspect, but makes no sense in a technical productivity aspect since the other part of the machine, e.g. the semi-processed workpieces, cannot be processed to the end, which would result in a loss of the parts. E.g. in adhesive processes or due to hygiene demands or because there are insufficient buffer stores within the machine. Which parts comprise the machine and which hazardous parts are slowed down or stopped are, for example, initially fixed in the control and evaluation unit for this purpose. Alternatively, the person directly on site can also make a reconfiguration.

In a further development of the invention, the mobile device has a visual display unit and/or an acoustic signal unit and/or a haptic signal unit or is at least wirelessly connected to such a one.

It can, for example, be displayed via display on the mobile device having the radio transponder how large the set protected volume is and also, for example, further properties, for example the set duration of the protected zone. In the simplest case, display LEDs are arranged at the radio transponder that change their color when the protected zone is changed to indicate the changed protected zone.

The data on the protected zone can also be displayed graphically on an external display of a machine control, for example, or on a mobile device such as a smartphone that receives the data from the radio transponder via the control and evaluation unit.

An acoustic output of the size of the protected zone can furthermore take place. Warnings and instructions can also be output to the person via the acoustic signal unit.

Haptic feedback can furthermore also be provided via the haptic signal unit so that the person learns of a configuration change or of a changed setting via a vibration alarm, for example.

Provision is also made that instead of via gestures, the radio transponder can switch over the protected zones via blowing on the radio transponder or by simply placing it in the hand. For example, temperature sensors, humidity sensors, and/or air pressure sensors can be integrated in the mobile device having the radio transponder for this purpose.

In a further development of the invention, the control and evaluation unit is configured to respectively determine a position of the radio transponders at different times and to determine a speed, an acceleration, a direction of movement, and/or at least one path or a trajectory of the radio transponders therefrom.

In accordance with the further development of the invention, the speeds and directions of movement of all the persons and mobile objects are preferably taken into account.

The position information serves for the calculation of probable movement sequences or trajectories of all the objects, that is the persons or mobile objects.

A family of movement sequences is determined for each person and for each mobile object with the aid of position information and is provided with a degree of probability, for example. The degree of probability is here estimated, for example, on the basis of the distance covered and/or on the direction of movement. Short direct paths are thus, for example, more probable than long indirect paths. The degree of probability can furthermore be estimated on the basis of a known history of routes of the objects. Paths that were used often in the past, for example, are thus more probable than new routes. The degree of probability can furthermore be estimated on the basis of known problems. A disturbed possible route will thus more probably be avoided than a non-disturbed route.

The most probable path, route, or trajectory is selected from a family of possible trajectories and the probabilities associated with them for every person and for every mobile object or for every vehicle.

A trajectory selected for each of N persons has a time-dependent risk classification assigned to it for each of M hazard sites that takes account of the spacing or the time-dependent spacing from hazard sites and optionally from details of the automation routines. In the simplest case, the risk can be determined binarily with an approach threshold to a hazard site. The risk classification therefore specifies how great the danger of a person is due to a hazard site at the time t.

These time-dependent risk classifications for every person can be summarized in the form of an N×M matrix and a standard/metric can be derived therefrom that represents a time-dependent hazard value for the total system or for the safety system. In the simplest case, it can be a time-dependent maximum of the hazard or also a sum of all matrix entries. This numerical description of the total system now permits the use of known optimization algorithms.

In a further development of the invention, the safety system has a map or a map model and a navigation of the movable machine takes place in the map or map model.

The map model here can also have information on interfering influences such as blocks or congestion information.

In this respect, the comparison with accessible routes in a floor plan can also serve for the check. For this purpose that region is marked as part of the configuration of the localization system in which mobile machines and person can dwell at all, in particular walkable or travelable routes. A localization outside these zones will thus signal a systematic measurement error. The degree of plausibility is reduced by the determined inconsistency.

These configured zones can likewise be used to improve the position accuracy in that the position information is corrected such that it is within an accessible zone. This correction can optionally take place using past localizations and trajectory estimates, e.g. with the aid of a Kalman filter. A correction will reduce the degree of plausibility of a piece of position information since the correction introduces an additional unsafety factor.

Additional information can also be made usable here by considering preceding values. The correction of inconsistent position values can therefore take place in the direction of the last valid measurement or in accordance with a trajectory estimate.

A comparison of radio locations that were determined with the aid of independent or different subsets of the available radio stations or anchor points is furthermore possible

The method makes use of the fact that as a rule all of the radio stations or anchor points are not required for the determination of the position and thus a plausibilization is possible from the measurement data themselves in that the same localization work is carried out by two different subgroups of the stationary radio stations. A cross-comparison with the expectation of the agreement is checked here as with the comparison of independent measurements of different radio transponders.

In a further development of the invention, the mobile device has at least two radio transponders, with the two radio transponders being arranged spaced apart from one another and with the control and evaluation unit being configured to cyclically compare the position data of the radio transponders and to form cyclically checked position data of the objects.

The safety system provides position data that can be used in a technical safety manner. This means that the position data of all the persons and hazard sites thus acquired can be used as the basis for a comprehensive, forward-looking, and productivity optimizing securing concept.

The position tracking takes place by means of radio location. The objects are provided with radio transponders via which a localization signal is regularly transmitted to the fixed position radio stations and a position or real time position of the respective object is generated or formed in the control and evaluation unit or in a central control.

The position information of a large number or of all of the mobile objects or mobile participants is thus available in real time in an industrial work environment.

Since at least two respective radio transponders are arranged at the respective object, errors in the localization information can be avoided since namely the localization information is always available from at least two independent radio transponders. The localization and the formed position signal is thus usable in the sense of functional safety. It is thus possible to discover and avoid erroneous localizations and to improve the quality of the spatial information.

A safety situation can be evaluated by the control and evaluation unit on the basis of a plurality or of a large number of checked position data or position information. This zone orientated or space oriented securing thereby provides the possibility of further risk reduction measures.

The present further development thus also makes it possible in the event of error prone radio location information to make a check in the operating environment that it can be used in a technical safety manner in the sense of machine safety. It is discovered in this process when localization errors occur outside a specified tolerance range, for example due to radio signals being too weak. Defective localization information is corrected where possible in this process and is made usable for further use. If this is not possible, an error control measure is initiated; the position value is marked as erroneous, for example.

The localization information, position information, or position data present are thus checked with respect to their reliability. A degree of reliability required for the further use can furthermore be associated with the position data.

The previously customary strategy in accordance with the prior art, according to which a machine is shut down or slowed down on the presence of a person in a hazardous zone, can admittedly also be provided in accordance with the further development, but it is also possible to avoid a shutting down or a direct slowing down since more information on the total situation and positions of the objects is present.

The localization of the radio transponders takes place by time of flight measurements of radio signals that are cyclically exchanged between the radio transponders and a plurality of fixed radio stations. This triangulation works very well when the signals are transmitted at a sufficient signal strength and on a straight or direct propagation path. Since this does not always have to be the case, a cross-comparison is now made between the position information of the radio transponders determined in this manner.

A redundant position determination with at least two radio transponders can be provided for technical safety reasons be. Since the radio transponders are small and relatively inexpensive, this error control measure is simple to implement and is very effective with respect to the error control.

The positions of both radio transponders of an object are determined and compared with one another in principle. A series of critical error cases can be controlled by the comparison of the positions of the radio transponders and in particular by the comparison with a known expectation, namely the spacing of the radio transponders in an expected zone.

An error according to which a radio transponder no longer delivers any position information is discovered and controlled. An error according to which the signals of the radio transponders are poor and are subject to a large systematic error is discovered and controlled. An error according to which a synchronization of the radio transponders is no longer possible is discovered and controlled.

In the sense of the further development, the positions are therefore determined by means of radio location for at least two radio transponders in a spaced apart arrangement and are compared with the expectation of a known spaced apart arrangement.

In a further development of the invention, sequence steps and/or process steps of the machine or plant are read by the control and evaluation unit.

Sequence steps and/or process steps planned for the future are thereby known to the control and evaluation unit and can be used for a forward-looking response and thus for a forward-looking influencing of the machine and/or of the mobile objects.

The sequence steps and/or process steps are here present, for example, in the form of programs or scripts that can be read by the control and evaluation unit. The programs are, for example, programs of a programmable logic controller.

The protected zone can, for example, be reorganized with reference to sequence steps or process steps of a process control. When the mobile object or the person has collected transported goods, the mobile object is given a larger protected zone when the transported goods project beyond the mobile object, for example an autonomous vehicle. The information on the collection can e.g. take place by NFC, an inductive proximity sensor, a barcode on the transported goods to the control and evaluation unit via the mobile object. The advantage is that transported goods per se do not need their own radio transponder with a larger protected zone to be able to be transported and the mobile object or the autonomous vehicle does not always require a maximum protected zone only because it sometimes transports a large workpiece or transported goods.

In a further development of the invention, at least one job planning for the plant and/or target coordinates of the mobile vehicles are read by the control and evaluation unit.

Sequence steps and/or process steps planned for the future are thereby known to the control and evaluation unit on the basis of the job planning and/or the target coordinates of the mobile objects or mobile vehicles and can be used for a forward-looking response and thus for a forward-looking influencing of the machine and/or of the mobile objects.

In a further development of the invention, the safety system has a database, with the database having data on the dwell probability of the objects and a time and/or space frequency distribution of the objects.

In accordance with the further development of the invention, statistical information that was derived from the observation of past routines can be generated and evaluated.

For example, frequently traveled routes and less frequently traveled routes of the mobile objects are known to the control and evaluation unit, whereby a possible risk for persons can be estimated better and with a higher probability. A possible risk to persons can be estimated better and with a higher probability due to the known dwell probabilities since, for example, mobile objects or mobile vehicles can travel at higher speeds at points with a small dwell possibility of persons than in zones in which persons will dwell with a high probability.

In a further development of the invention, a degree of productivity of the plant, of the machine, and/or of the objects is detected by means of the control and evaluation unit.

A degree of productivity is defined as an optimization parameter in addition to the already known risk classifications. In the simplest case, an accumulated shutdown time of the productive routines or a process cycle time is used here. The use of throughput rates of travel routes, energy, and/or resource consumption is, however, also possible.

While taking account of a marginal condition that a standard of the risk classification for a person always has to be below a limit value that represents a tolerable risk, the degree of productivity is optimized with the aid of the variation of the trajectories or paths or other process parameters. This can be carried out, for example, using variation approaches or with a simple testing of the available trajectories and process parameters. The primary optimization value is the productivity.

In addition, the risk classification itself can enter into the optimization to reduce the total risk. This is of interest, for example, when there are a plurality of alternative trajectories that result in a comparable productivity, for instance when a mobile object has two possibilities of reaching a target point, with, for example, the mobile object coming into the proximity of a single person on a first route and the mobile object coming into the proximity of a plurality of persons on the second alternative route. The total risk is here lower on the first route than on the second route having more persons that can be put at risk.

It is decisive here that the trajectories of the individual participants are not reactionless, i.e. can have an influence on the risk classification of other persons. The optimization therefore sensibly takes place in the total system.

In a further development of the invention, warnings are output to the persons by means of at least one display unit.

An improved system state is achieved by warnings or instructions by means of the display unit.

It can thus be dynamically displayed, for example, for a zone by means of a display unit whether a presence of persons in this zone is allowed or not. Routes recommended for persons can furthermore be displayed or a warning against non-recommended routes can be given by means of the display unit, for example.

In a further development of the invention, the control and evaluation unit is configured to control and thus to influence the machine and/or the mobile vehicle.

The optimum system state is achieved by a control of machines and process routines.

The effectiveness of the different effects and their influence on productivity differ here and are used for a prioritization of the measures. It must, for example, be anticipated that a warning to a person or the instruction to take an alternative route is ignored by persons. On a directly impending risk, use is therefore made of the very much more reliable controls of the machines, e.g. a slowing down of the machine or an emergency stop of the machine.

An evaluation is here made at every point in time from the observation of the time development of the safety system whether the safety system is optimized and whether the constraints according to which a risk can be tolerated are observed. This evaluation enters as feedback into the selection of the control measures.

The following possibilities are provided for the influencing, for example:
an emergency stop of a machine or of a mobile object or vehicle;
a slowing down of a machine or of a mobile object or vehicle;
a change of a path plan of a person or of a mobile object or vehicle
a change of an order of individual process steps of an automation routine;
warnings to a person;
instructions to a person, e.g. indications of an alternative travel path.

In a further development of the invention, plausibility values are formed on the basis of the detected signal strengths of the radio signals of the radio transponders and from the comparison of the position data of the radio transponders.

The further development provides position data that can be used in a technical safety manner. This means that the position data of all the persons and hazard sites thus acquired can be used as the basis for a comprehensive, forward-looking, and productivity optimizing securing concept.

The position tracking takes place by means of radio location. The objects are provided with radio transponders via which a localization signal is regularly transmitted to the fixed position radio stations and a position or real time position of the respective object is generated or formed in the control and evaluation unit or in a central control.

In accordance with the further development, the position information of a large number or of all of the mobile objects or mobile participants are available in real time in an industrial work environment.

In a further development of the invention, the spacings between the radio transponders are known to the control and evaluation unit and are stored in a memory of the control and evaluation unit.

It is thereby possible to teach and store different objects having individual distances of the radio transponders so that the safety system can identify stored objects and can distinguish them from non-stored objects.

In a further development of the invention, at least three radio transponders are arranged, with the control and evaluation unit being configured to form orientation data of the object from the position data of the radio transponders.

Two radio transponders are, for example, arranged on the shoulders of a vest of a person. A further transponder is, for example, arranged at a helmet of the person.

An overdetermined system is thereby advantageously present in a technical safety manner. Even if a radio transponder were to fail or if its radio signals were not detectable, two radio transponders would still remain that can be evaluated redundantly. A highly available safety system is thereby present

In a further development of the invention, the radio transponders each have at least one time measurement unit, with the radio stations likewise respectively having at least one time measuring unit, with the radio stations being configured to read and/or describe the times of the time measurement units of the radio transponders and with the radio stations being configured to synchronize the times of the time measurement units of the radio transponders and/or with the radio stations being configured to compare the times of the radio transponders with the times of the time measurement units of the radio stations.

A more precise position determination is thereby possible that can also be carried out permanently precisely by the synchronization, in particular with moving objects.

In a further development of the invention, the safety system has optical sensors, radar sensors, RFID sensors, and/or ultrasound sensors for the localization and detection of the objects.

The position data or position information can be compared with safe or unsafe position data or position information that were/was detected at spots at specific locations in the operating environment with the aid of optical sensors, radar sensors, RFID sensors and/or ultrasound sensors.

An example is the comparison with the position data that were determined in the field of vision of an optical sensor, for example a 3D camera. It can be in an intersection zone, for example. The position relative to the 3D camera is determined in this process on the detection of an object in the field of vision and the global position of the object is derived using the known position of the 3D camera. In this respect, both statically arranged optical sensors and mobile optical sensors whose position and orientation are known through other sources are provided. A check is subsequently made as to whether an object that matches this position value is in a list of the objects tracked by means of radio location. On sufficient agreement, the position value of the radio location is deemed checked. In this case, a diverse redundant approach has confirmed the measurement.

The optical position data typically have a better accuracy and can additionally be used to improve the position accuracy of the person or of the mobile machine.

The plausibility of a position value is therefore the greater, the better the agreement between the optical position determination and the radio location and the less ambiguous the association between the optical position determination and the radio location is also possible. In the above-shown case, the additional difficulty can, for example, be present that it is not possible to reliably determine whether a first radio location does not possibly also belong to a second optical localization and vice versa. Such ambiguities are considered in the plausibility. This consideration can also take place in that the association is carried out in a safety relevant manner such that a minimal deviation between the radio location and the optical position results. It can alternatively also take place in that preceding position values are tracked and the association is made such that the interval from the preceding measurement is minimized.

In a further development of the invention, the radio location system is an ultra wideband radio location system, with the frequency used being in the range from 3.1 GHz to 10.6 GHz, with the transmission energy per radio station amounting to a maximum of 0.5 mW.

An absolute bandwidth in an ultra wideband radio location system amounts to at least 500 MHz or a relative bandwidth amounts to at least 20% of the central frequency.

The range of such a radio location system amounts, for example, to 0 to 50 m. In this respect, the short time duration of the radio pulses is used for the localization.

The radio location system thus only transmits radio waves having a low energy. The system can be used very flexibly and has no interference.

A plurality of radio stations, for example more than three, are preferably arranged that monitor at least some of the movement zone of the person or of the object.

In a further development of the invention, a change of the safety function of the safety system takes place on the basis of the checked position data by means of the control and evaluation unit.

A change of the safety function of the safety function of the safety system takes place on the basis of position data by means of the control and evaluation unit.

If a predetermined position has been recognized that is stored, for example, the control and evaluation unit can switch over to a different protective measure or safety function. The switching over of the protective measure can comprise, for example, a switching over of measured data contours, a switching over of protected zones, a size or shape matching of measured data contours or protected zones, and/or a switching over of the properties of a protected zone. The properties of a protected field include, for example, the resolution and/or the response time of the protected zone. A switching over of the protective measure can also be a safety function such as a force restriction of the drive to which the switchover is made.

In a further development of the invention, position data checked by means of the control and evaluation unit are checked for agreement with stored position data of a safe point of interest.

A check of the radio location can additionally optionally be carried out at specific monitoring points that, for example, deliver both optically determined position information and position information detected by radio location in the sense that a check is made as to whether a radio location has taken place at all for a detected object. Such a confirmation can reveal the safety critical error cases of a missing or non-functioning tag and can satisfy the demands on a cyclic test in the sensor of the standard ISO 13849-1.

The comparison with independent position data can also take place at known interaction points. For example, by actuation of a switch or on a monitored passing through a door. At this moment, the position of the operator is very precisely known and can be used for a validation of the position data or of the position information. A corresponding process is also possible with autonomous vehicles. The position is very accurately known on docking at a charge station or on an arrival at transfer stations and can be used for checking the radio location and technical safety error control.

A comparison of radio locations that were determined with the aid of independent or different subsets of the available radio stations or anchor points is furthermore possible

The method makes use of the fact that as a rule all of the radio stations or anchor points are not required for the determination of the position and thus a plausibilization is possible from the measurement data themselves in that the same localization work is carried out by two different subgroups of the stationary radio stations. A cross-comparison with the expectation of the agreement is checked here as with the comparison of independent measurements of different radio transponders.

The invention will also be explained in the following with respect to further advantages and features with reference to the enclosed drawing and to embodiments. The Figures of the drawing show in:

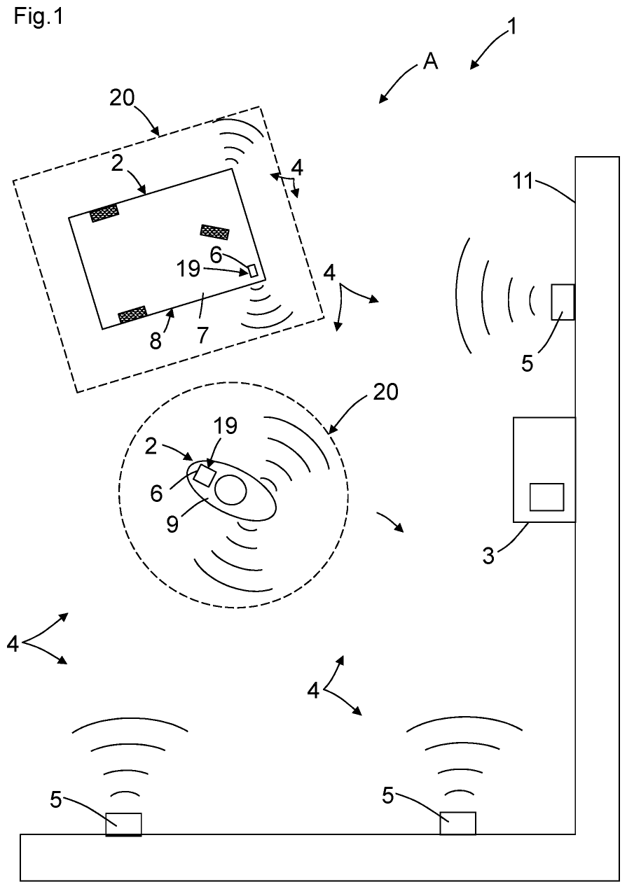

FIGS. 1 to 3 and FIGS. 7 and 8 respectively, a safety system for localizing at least two objects;

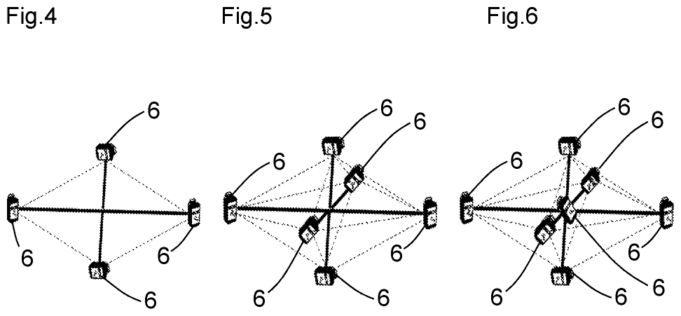

FIGS. 4 to 6 respectively, a plurality of radio transponders on an object.

In the following Figures, identical parts are provided with identical reference numerals.

FIG. 1 shows a safety system 1 for localizing at least one object 2, having at least one control and evaluation unit 3, having at least one radio location system 4, wherein the radio location system 4 has at least three arranged radio stations 5, wherein at least one mobile device 19 having at least one radio transponder 6 is arranged at the object 2, wherein position data of the radio transponder 6 and thus position data of the objects 2 can be determined by means of the radio location system 4, wherein the position data can be transmitted from the radio station 5 of the radio location system 4 to the control and evaluation unit 3, and/or the position data can be transmitted from the radio transponder 6 to the control and evaluation unit 3, wherein the control and evaluation unit 3 is configured to cyclically detect the position data of the radio transponder 6, wherein the objects 2 are persons 9 or mobile objects 7, wherein the radio transponder 6 has identification, wherein a respective radio transponder 6 is associated with either a person 9 or a mobile object 7, wherein the control and evaluation unit 3 is configured to distinguish the persons 9 and mobile objects 7, and wherein a spatially expanded protected volume 20 is formed around the radio transponder 6.

The terms protected volume 20 and protected zone 20 are used as synonymous terms in the following.

The objects 2 are protected over the spatially expanded protected volume 20. If the object 2 comes too close to a hazard site, this is reported to the object 2, for example visually, and the object 2 can move away from the hazard site again.

In the case of persons 9 as objects 2, the person 9 can approach the hazard site on foot, for example, up to a permitted minimum distance. As soon as the person 9 approaches the minimum distance, the person 9 is visually warned, for example. Provision can simultaneously also be made that the hazard site 9 reacts to the approach of the person 9 and reduces the degree of a possible hazard.

In the case of mobile objects 7 that are, for example, autonomously driving vehicles, the mobile object 7 can, for example. approach the hazard site while driving, for example, up to a permitted minimum distance. As soon as the mobile object 7 has approached the minimum distance, the mobile object 7 is warned, for example, by means of a command from the control and evaluation unit 3.

Provision can simultaneously also be made that the hazard site reacts to the approach of the mobile object 7 and reduces the degree of a possible hazard. A plurality of mobile objects 7 can also mutually react, for example by evasive maneuvers and/or braking maneuvers.

A securing is possible over larger zones by the safety system 1, that is, for example, of a large number of work stations, of a large number of robots, or, for example, even of whole production facilities, since not only a local presence or approach of persons 9 is detected, but rather a position of a large number of persons 9 and mobile objects 7 or mobile machines active in an environment or zone can be detected and can be continuously tracked.

The localization of the radio transponders 6 takes place by time of flight measurements of radio signals that are cyclically exchanged between the radio transponders 6 and a plurality of fixed position radio stations 5. This triangulation works very well when the signals are transmitted at a sufficient signal strength and on a straight or direct propagation path.

The movable or mobile object 7 can, for example, be a mobile vehicle 8, a guideless vehicle, a driverless vehicle or autonomous vehicle, an automated guided vehicle, a mobile robot, an industrial mobile robot, or a robot having movable robot arms. The mobile object 7 thus has a drive and can be moved in different directions.

The person 9 can, for example, be an operator or a service engineer. The radio transponders 6 are arranged on the clothing or on the equipment of the person 8, for example. It can here, for example, be a vest to which the radio transponders 6 are firmly fixed. The radio transponders 6 are arranged, for example, on the shoulders and in the chest and back areas. The radio transponders 6 can, however, also be arranged at different locations on the person 0. Two radio transponders 6 are, for example, arranged on the shoulders of a vest of a person 9.

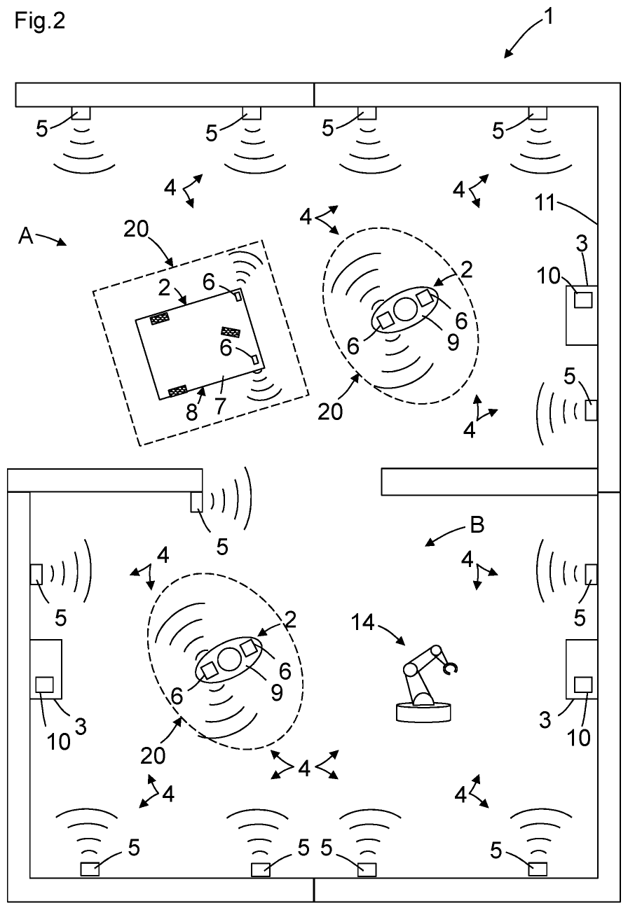

FIG. 2 shows two zones A and B that are connected to one another via a passage and that are connected to one another by means of boundaries or walls 11.

In accordance with FIG. 2, a securing is possible over larger zones A and B, that is, for example, of a large number of work stations, of a large number of robots, or, for example, of whole production facilities, since not only a local presence or approach of persons 9 is detected, but rather a position of a large number of persons 9 and mobile machines 8 active in an environment or zone A, B can be detected and can be continuously tracked. A plurality of radio stations 5 are provided for this purpose, for example.

In accordance with FIG. 2, the size and shape of the protected volume 20 is configurable via a configuration device, with a wireless communication link being present between the configuration device and the mobile device or the radio transponder 6.

The size and shape of the protected volume 20 can thus be individually adapted. The required safety standards naturally have to be observed here. The configuration device can be a PC, a portable device, a tablet computer, a smartphone, or similar.

The wireless communication link can be near field communication, abbreviated to NFC.

The wireless communication link can, however, also be a radio link in accordance with the Bluetooth standard or in accordance with the Bluetooth low energy standard, abbreviated to BLE.

In accordance with FIG. 2, the shape of the protected volume 20 is approximately rectangular, parallelepiped-shaped, or oval. Other shapes can, however, also be provided for the protected volume 20.

In accordance with FIG. 2 at least two radio transponders 6 are provided, with the radio transponders 6 having protected volumes 20 of different sizes.

A plurality of radio transponders 6 are thereby provided from which a user only has to select the suitable one.

A time-consuming reprogramming and technical safety acceptance of protected zones by a trained safety engineer is thereby not necessary.

The person 9 can simply increase the safety for critical work by a larger protected zone 20.

In accordance with FIG. 2, the mobile device having the radio transponder 6 has at least one acceleration sensor and the size of the protected volume 20 can be set in dependence on sensor data of the acceleration sensor. The acceleration sensor is, for example, evaluated directly on the mobile device having the radio transponder 6 or is evaluated by the control and evaluation unit 3.

It is thereby possible, for example, that the radio transponder 6 is configurable or settable by a simple shaking by hand. The size and/or shape of the protected volume 20 can thus be set by a simple shake, for example. Such a configuration can also be time limited, for example. So that the original protected volume 20 is automatically activated again after a specific time.

It is furthermore also possible to act on a hazard site of a machine 14 via an acceleration movement of the mobile device or of the radio transponder 6. It is, for example, possible due to the movement of the radio transponder 6 to slow down or to stop a hazardous movement of a machine 14, for example. A machine 14 can, for example, also be put into a setting mode via the movement of the radio transponder 6.

To ensure a minimum amount of safety, the protected volume 20 can, for example, not be completely shut down by the counter measure or be cut down to a radius of ZERO. It is, however, always possible to increase the protected volume 20.

The radio transponders 6 can be visually distinguished in accordance with FIG. 2. Different radio transponders 6 having differently preset protected volumes 20, for example, have different colors, different markings, and/or different symbols. A person 9 who selects the radio transponders 6 for himself, for another person 9, or for the application on a mobile object 7 can thereby determine which radio transponder 6 has which protected volume 20 or which protected volumes 20.

Red radio transponders, for example, have large protected volumes 20; yellow radio transponders have medium-sized protected volumes 20; and blue radio transponders 6 or green radio transponders 6 have a smaller or a customary normally sized protected volume 20. The radio transponders 6 can be intuitively distinguished via such a color marking.

The shape of the protected volume 20 can, for example, be recognized in the symbol on the radio transponder so that the suitable radio transponder 6 and thus the suitable protected volume 20 is selected with reference to the symbol.

In accordance with FIG. 2, the size of the protected volume 20 of the radio transponder 6 is dependent on the position data of the same radio transponder 6.

The protected zone 20 is, for example, dependent on the vertical location of the radio transponder 6. A height over a floor is, for example, determined directly via the radio location. For example, the height can also be checked via an air pressure sensor integrated in the radio transponder 6 or the accuracy of the height input can be improved.

The control and evaluation unit 3, for example, compares a measured position or height of the person 9 with an environmental map of the factory facility. The control and evaluation unit 3 can determine the height at which the person 9 is located on the basis, for example, of existing 3D data of the environmental map. The same applies to an object 2 or a mobile object 7, for example an autonomous vehicle, that moves through a factory facility, in particular through a multistory factory facility.

The protected zone 20 can, for example, be made bigger or smaller when the person 9 is outside a predetermined work zone. E.g. when the person 9 who bears the radio transponder is on a ladder or on a lifting cart or, in another case, works on the ground or even lies flat on the ground.

A change of the protected zones 20 can thus, for example, be carried out in dependence on a detected height location.

In accordance with FIG. 2, the size of the protected volume of the radio transponder 6 is dependent on the position data of a different radio transponder 6.

The protected zone 20 is changed, for example, when two radio transponders 6 fall below a specific minimum spacing for a specific time period. For example, when a person 9 approaches a mobile object 7 or when, for example, two mobile objects 7 move toward one another.

The control and evaluation unit 3 can, for example, control a path calculation for mobile vehicles 8, with traveled independent individual routes, for example, being combined into convoy groups to provide space for persons 9.

In accordance with FIG. 2, the size and/or the shape of the protected volume 20 is changed for a limited time and the previously activated size and/or shape is reestablished after an elapse of the time.

In accordance with FIG. 2, the safety system 1 has at least one machine 14 arranged as stationary and having a hazard site of the machine 14, with the position of the hazard site arranged as stationary being known to the control and evaluation unit 3, with the machine 14 being able to be influenced in dependence on position data of the radio transponder 6.

The protected zone 20 can, for example, be changed when a person approaches a machine 14 or works on a machine 14, for example.

In accordance with FIG. 2, the mobile device has a visual display unit and/or an acoustic signal unit and/or a haptic signal unit or is at least wirelessly connected to such a one.

It can, for example, be displayed via a display on the mobile device having the radio transponder 6 how large the set protected volume 20 is and also, for example, further properties, for example the set duration of the protected zone 20. In the simplest case, display LEDs are arranged on the mobile device or the radio transponder 6 that change their color when the protected zone 20 is changed to indicate the changed protected zone. 20

The data on the protected zone 20 can also be displayed graphically on an external display of a machine control, for example, or on a mobile device such as a smartphone that receives the data from the radio transponder 6 via the control and evaluation unit 3.

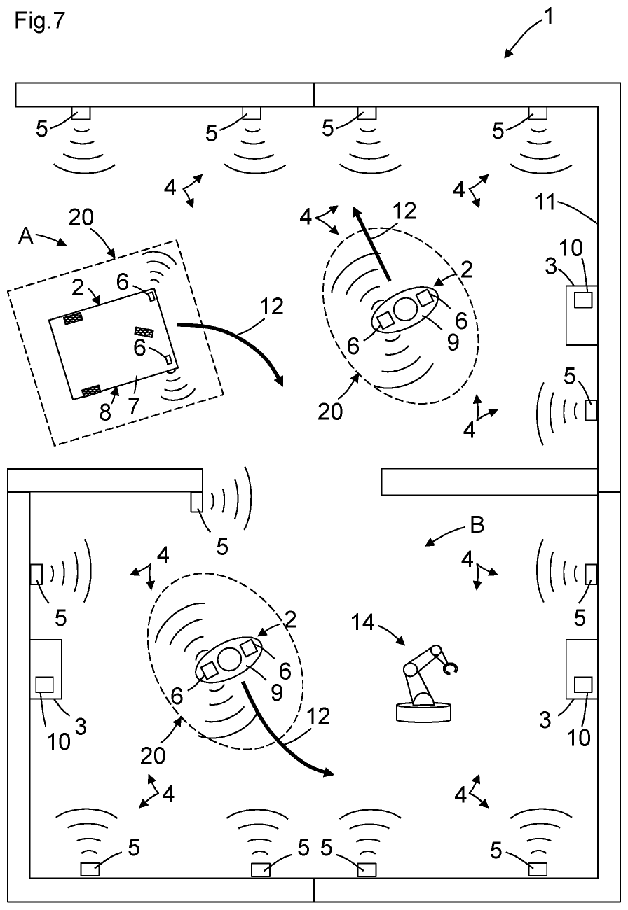

In accordance with FIG. 7, the control and evaluation unit 3 is configured to respectively determine a position of the radio transponders 6 at different points in time and to determine a speed, an acceleration, a direction of movement and/or a path 12 or a trajectory 12 of the radio transponders 6 from it.

The speeds and directions of movement of all the persons 9 and mobile objects 7 are preferably taken into account.

The position information serves for the calculation of probable movement sequences or trajectories 12 of all the objects 2, that is the persons 9 or mobile objects 7.

A family of movement sequences is determined for each person 9 and for each mobile object 7 with the aid of position information and is provided with a degree of probability, for example. The degree of probability is here estimated, for example, on the basis of the distance covered and/or on the direction of movement. Short direct paths are thus, for example, more probable than long indirect paths. The degree of probability can furthermore be estimated on the basis of a known history of routes of the objects 2. Paths that were used often in the past, for example, are thus more probable than new routes. The degree of probability can furthermore be estimated on the basis of known problems. A disturbed possible route will thus more probably be avoided than a non-disturbed route.

The most probable path 12, route, or trajectory 12 is selected from a family of possible trajectories 12 and the probabilities associated with them for every person 9 and for every mobile object 7 or for every vehicle.

In accordance with FIG. 7, the safety system has a map or a map model and a navigation of the movable objects takes place in the map or map model.

The map model here can also have information on interfering influences such as blocks or congestion information.

In this respect, the comparison with accessible routes in a floor plan can also serve for the check. For this purpose that region is marked as part of the configuration of the localization system in which mobile machines 7 and persons 9 can dwell at all, in particular walkable or travelable routes. A localization outside these zones will thus signal a systematic measurement error. The degree of plausibility is reduced by the determined inconsistency.

Additional information can also be made usable here by considering preceding values. The correction of inconsistent position values can therefore take place in the direction of the last valid measurement or in accordance with a trajectory estimate.

A comparison of radio locations that were determined with the aid of independent or different subsets of the available radio stations 5 or anchor points is furthermore possible

In accordance with FIG. 2, the mobile device has at least two radio transponders 6, with the two radio transponders 6 being arranged spaced apart from one another and with the control and evaluation unit 3 being configured to cyclically compare the position data of the radio transponders 6 and to form cyclically checked position data of the objects 2.

In accordance with FIG. 2, position data usable in a technical safety manner are provided. This means that the position data of all persons 9 and objects 7 thus acquired can be used as the basis for a comprehensive, forward-looking, and productivity optimizing securing concept.

The position information of a large number or of all of the mobile objects 7 or mobile participants is available in real time in an industrial work environment due to the safety system 1.

Since at least two respective radio transponders 6 are arranged at the respective object 2, errors in the localization information can be avoided since namely the localization information is always available from at least two independent radio transponders 6. The localization and the formed position signal is thus usable in the sense of functional safety. It is thus possible to discover and avoid erroneous localizations and to improve the quality of the spatial information.

The localization information, position information, or position data present are thus checked with respect to their reliability. A degree of reliability required for the further use can furthermore be associated with the position data.

The previously customary strategy in accordance with the prior art, according to which a machine 14 is shut down or slowed down on the presence of a person 9 in the hazardous zone, can admittedly also be provided here, but it is also possible to avoid a shutting down or a direct slowing down since more information on the total situation and positions of the objects 2 is present.

The positions are therefore determined by means of radio location for at least two radio transponders 6 in a spaced apart arrangement and they are compared with the expectation of a known spaced apart arrangement.

In accordance with FIG. 2, sequence steps and/or process steps of the machine 14 or plant are read by the control and evaluation unit 3.

Sequence steps and/or process steps planned for the future are thereby known to the control and evaluation unit 3 and can be used for a forward-looking response and thus for a forward-looking influencing of the machine 14 and/or of the mobile objects 7.

The protected zone 20 can, for example, be reorganized with reference to sequence steps or process steps of a process control. When the mobile object 7 or the person 9 has collected transported goods, the mobile object 7 is given a larger protected zone 20 when the transported goods project beyond the mobile object 7, for example an autonomous vehicle. The information on the collection can e.g. take place by NFC, an inductive proximity sensor, a barcode on the transported goods to the control and evaluation unit 3 via the mobile object 7.

In accordance with FIG. 2, at least one job planning for the plant and target coordinates of the mobile vehicles 8 are read by the control and evaluation unit 3.

Sequence steps and/or process steps planned for the future are thereby known to the control and evaluation unit 3 on the basis of the job planning and the target coordinates of the mobile objects 7 or mobile vehicles 8 and can be used for a forward-looking response and thus for a forward-looking influencing of the machine 14 and/or of the mobile objects 7.

In accordance with FIG. 7, the safety system 1 has a database, with the database having data on the dwell probability of the objects 2 and a time and/or space frequency distribution of the objects 2.

Statistical information that was derived from the observation of past routines can thereby be generated and evaluated.

For example, frequently traveled routes and less frequently traveled routes of the mobile objects 7 are known to the control and evaluation unit 3, whereby a possible risk for persons 9 can be estimated better and with a higher probability. A possible risk to persons 9 can be estimated better and with a higher probability due to the known dwell probabilities since, for example, mobile objects or mobile objects 7 or mobile vehicles 8 can travel at higher speeds at points with a small dwell possibility of persons 9 than in zones in which persons 9 will dwell with a high probability.

In accordance with FIG. 7, a degree of productivity of the plant, of the machine 14, and/or of the objects 2 is detected by means of the control and evaluation unit 3.

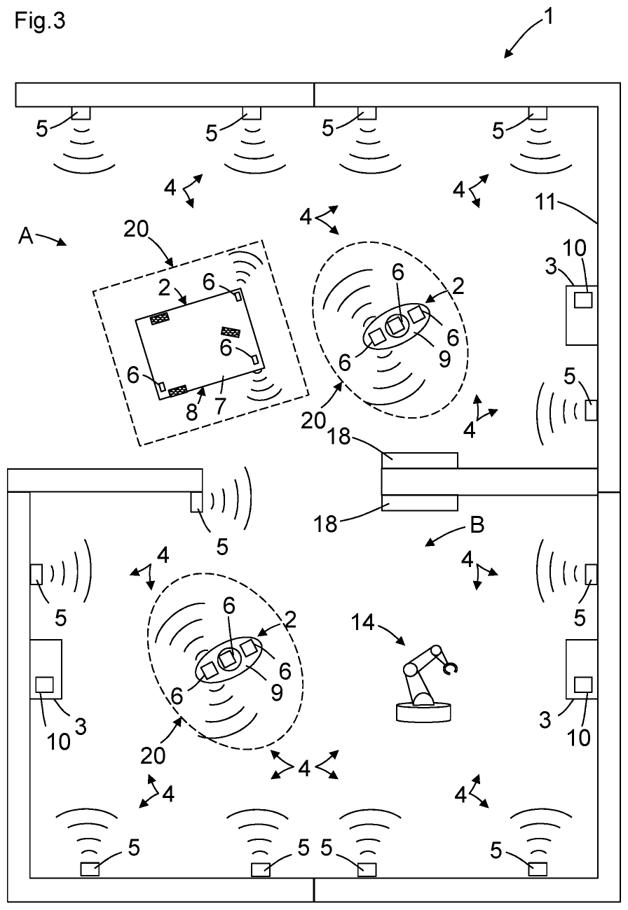

In accordance with FIG. 3, warnings are output to the persons by means of at least one display unit 18.

An improved system state is achieved by warnings or instructions by means of the display unit 18.

It can thus be dynamically displayed, for example, for a zone by means of a display unit 18 whether a presence of persons 9 in this zone A, B is allowed or not. Routes recommended for persons 9 can furthermore be displayed or a warning against non-recommended routes can be indicated by means of the display unit 18, for example.

In accordance with FIG. 3, the control and evaluation unit 3 is configured to control and thus to influence the machine 14 and/or the mobile vehicle 8.

The effectiveness of the different effects and their influence on productivity differ here and are used for a prioritization of the measures. It must, for example, be anticipated that a warning to a person 9 or the instruction to take an alternative route is ignored by persons 9. On a directly impending risk, use is therefore made of the very much more reliable controls of the machines 14, e.g. a slowing down of the machine 14 or an emergency stop of the machine 14.

An evaluation is here made at every point in time from the observation of the time development of the safety system 1 whether the safety system 1 is optimized and whether the constraints according to which a risk can be tolerated are observed. This evaluation enters as feedback into the selection of the control measures.

The following possibilities are provided for the influencing, for example:
an emergency stop of a machine 14 or of a mobile object 7 or vehicle;
a slowing down of a machine 14 or of a mobile object 7 or vehicle;
a change of a path plan of a person or of a mobile object or vehicle
a change of an order of individual process steps of an automation routine;
warnings to a person 9;
instructions to a person 9, e.g. indications of an alternative travel path.

In accordance with FIG. 3, plausibility values are formed on the basis of the detected signal strengths of the radio signals of the radio transponders 6 and from the comparison of the position data of the radio transponders 6.

The position information of a large number or of all of the mobile objects 7 or mobile participants is thus available in real time in an industrial work environment.

In accordance with FIG. 3, the spacings between the radio transponders 6 are known to the control and evaluation unit 3 and are stored in a memory 10 of the control and evaluation unit 3.

In accordance with FIG. 3, at least three radio transponders 6 are arranged, with the control and evaluation unit 3 being configured to form orientation data of the object 2 from the position data of the radio transponders 6.

Two radio transponders 6 are, for example, arranged on the shoulders of a vest of a person 9. A further radio transponder 6 is, for example, arranged on a helmet of the person 9.

In accordance with FIG. 4 at least four, in accordance with FIG. 5 at least six, or in accordance with FIG. 6 at least eight radio transponders 6 are arranged on the object, with two respective radio transponders 6 each lying on a straight line, with the straight lines each being perpendicular to one another.

Radio transponders 6 are thereby respectively arranged in pairs, with the respective pairs each having a different orientation. An orientation from every direction is thereby unique. Furthermore, a radio transponder 6 can also be arranged at the point of intersection of the straight lines so that a single radio transponder 6 forms a center or a central position point that can be used as a reference position.

In accordance with FIG. 3, the radio transponders 6 each have at least one time measurement unit, with the radio stations 5 likewise respectively having at least one time measuring unit, with the radio stations 5 being configured to read and describe the times of the time measurement units of the radio transponders 6 and with the radio stations 5 being configured to synchronize the times of the time measurement units of the radio transponders 6 and to compare the times of the time measurement units of the radio transponders 6 with the times of the time measurement units of the radio stations 5.

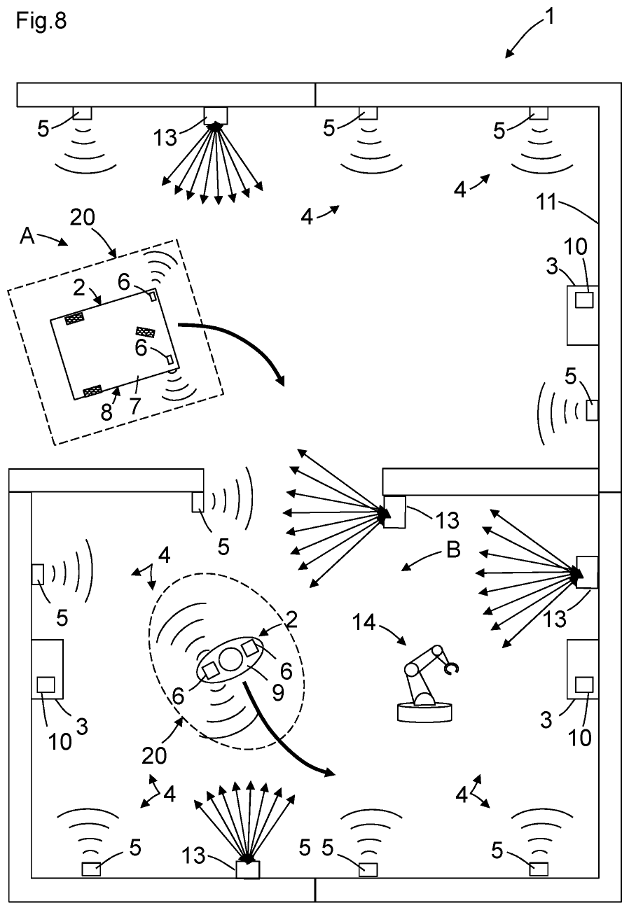

In accordance with FIG. 8, the safety system 1 has optical sensors 13, radar sensors, RFID sensors, and/or ultrasound sensors for the localization and detection of the objects 2.

The position data or position information can be compared with safe or unsafe position data or position information that were/was detected at spots at specific locations in the operating environment with the aid of optical sensors 13, radar sensors, RFID sensors and/or ultrasound sensors.

The plausibility of a position value is therefore the greater, the better the agreement between the optical position determination and the radio location and the less ambiguous the association between the optical position determination and the radio location is also possible.

In accordance with FIG. 2, the radio location system 4 is an ultrawide band radio location system, with the frequency used being in the range from 3.1 GHz to 10.6 GHz, with the transmission energy amounting to a maximum of 0.5 mW per radio station.

A plurality of radio stations 5, for example more than three, are preferably arranged that monitor at least some of the movement zone of the person 9 or object 2.

In accordance with FIG. 2, a change of the safety function of the safety system 1 takes place on the basis of the checked position data by means of the control and evaluation unit 3.

A change of the safety function of the safety function of the safety system 1 takes place on the basis of position data by means of the control and evaluation unit 3.

If a predetermined position has been recognized that is stored, for example, the control and evaluation unit 3 can switch over to a different protective measure or safety function. The switching over of the protective measure can comprise, for example, a switching over of measured data contours, a switching over of protected zones 20, a size or shape matching of measured data contours or protected zones 20, and/or a switching over of the properties of a protected zone 20.

In accordance with FIG. 2, position data checked by means of the control and evaluation unit 3 are checked for agreement with stored position data of a safe point of interest.

A check of the radio location can optionally additionally be carried out at specific monitoring points that, for example, deliver both optically determined position information and position information detected by radio location in the sense that a check is made as to whether a radio location has taken place at all for a detected object 2. Such a confirmation can reveal the safety critical error cases of a missing or non-functioning tag and can satisfy the demands on a cyclic test in the sensor of the standard ISO 13849-1.

The comparison with independent position data can also take place at known interaction points. For example, by actuation of a switch or on a monitored passage through a door. At this moment, the position of the person 9 is very precisely known and can be used for a validation of the position data or of the position information. A corresponding process is also possible with autonomous vehicles. The position is very accurately known on docking at a charge station or on the arrival at transfer stations and can be used for checking the radio location and technical safety error control.

### REFERENCE NUMERALS

1 safety system
2 object
3 control and evaluation unit
4 radio location system
5 radio stations
6 radio transponder
7 mobile objects
8 mobile vehicles
9 person
10 memory
11 wall/boundary
12 path/trajectory
13 optical sensor
14 machine
18 display unit
19 mobile device
20 protected volume/protected zone
A zone
B zone

1. A safety system for localizing at least one object, the safety system comprising
at least one control and evaluation unit, and
at least one radio location system,
wherein the radio location system has at least three arranged radio stations;
wherein at least one mobile device having at least one radio transponder is arranged at the object;
wherein position data of the radio transponder and thus position data of the objects can be determined by means of the radio location system;
wherein the position data can be transmitted from the radio station of the radio location system to the control and evaluation unit;
and/or the position data can be transmitted from the radio transponder to the control and evaluation unit
wherein the control and evaluation unit is configured to cyclically detect the position data of the radio transponder,
with the objects being persons or mobile objects,
with the radio transponders having identification, with a respective radio transponder being associated with at least either one person or one mobile object, with the control and evaluation unit being configured to distinguish the persons and mobile objects, and
with a spatially expanded protected volume being formed around the radio transponder.

2. The safety system in accordance with claim 1, wherein a size and/or a shape of the protected volume is configurable via a configuration device, with a wireless communication link being present between the configuration device and the radio transponder and/or one of the radio stations.

3. The safety system in accordance with claim 1, wherein a shape of the protected volume is rectangular, parallelepiped-shaped, cylindrical, spherical, or oval, or cruciform.

4. The safety system in accordance with claim 1, wherein at least two radio transponders are provided, with the radio transponders each having protected volumes of different sizes.

5. The safety system in accordance with claim 1, wherein the radio transponder has at least one acceleration sensor; and wherein a size and/or a shape of the protected volume can be set in dependence on sensor data of the acceleration sensor.

6. The safety system in accordance with claim 1, wherein the radio transponders can be visually distinguished.

7. The safety system in accordance with claim 1, wherein the size and/or shape of the protected volume of the radio transponder is dependent on the position data of the same radio transponder.

8. The safety system in accordance with claim 1, wherein the size and/or shape of the protected volume of the radio transponder is dependent on the position data of a different adjacent radio transponder.

9. The safety system in accordance with claim 1, wherein the size and/or the shape of the protected volume is changed for a limited time and the previously activated size and/or shape is reestablished after an elapse of the time.

10. The safety system in accordance with claim 1, wherein the safety system has at least one machine arranged as stationary and having a hazard site of the machine, with the position of the hazard site arranged as stationary being known to the control and evaluation unit, and with the machine being able to be influenced in dependence on the position data of the radio transponder.

11. The safety system in accordance with claim 1, wherein the mobile device has a visual display unit and/or an acoustic signal unit and/or a haptic signal unit or is at least wirelessly connected to such a one.

12. The safety system in accordance with claim 1, wherein the control and evaluation unit is configured to respectively determine a position of the radio transponders at different points in time and to determine a speed, an acceleration, a direction of movement and/or at least one path or a trajectory of the radio transponders from it.

13. The safety system in accordance with claim 1, wherein the safety system has a map or a map model; and wherein a navigation of the movable machine takes place in the map or in the map model.

14. The safety system in accordance with claim 1, wherein the mobile device has at least two radio transponders, with the two radio transponders being arranged spaced apart from one another and with the control and evaluation unit being configured to cyclically compare the position data of the radio transponders and to form cyclically checked position data of the objects.

15. The safety system in accordance with claim 1, wherein sequence steps and/or process steps of the machine or plant are read by the control and evaluation unit.

16. The safety system in accordance with claim 1, wherein at least one job planning for the plant and/or target coordinates of the mobile objects are read by the control and evaluation unit.

17. The safety system in accordance with claim 1, wherein the safety system has a database, with the database having data on the dwell probability of the objects and a time and/or space frequency distribution of the objects.

18. The safety system in accordance with claim 1, wherein a degree of productivity of the plant, of the machine, and/or of the objects is detected by means of the control and evaluation unit.

19. The safety system in accordance with claim 1, wherein warnings are output to the persons by means of at least one display unit.

20. The safety system in accordance with claim 1, wherein the control and evaluation unit is configured to control and thus to influence the machine and/or the mobile vehicle.

21. The safety system in accordance with claim 1, wherein plausibility values are formed on the basis of the detected signal strengths of the radio signals of the radio transponders and from the comparison of the position data of the radio transponders.

22. The safety system in accordance with claim 1, wherein the spacings between the radio transponders are known to the control and evaluation unit and are stored in a memory of the control and evaluation unit.

23. The safety system In accordance with claim 1, wherein at least three radio transponders are arranged, with the control and evaluation unit being configured to form orientation data of the object from the position data of the radio transponders

24. The safety system in accordance with claim 1, wherein the radio transponders each have at least one time measurement unit, with the radio stations likewise respectively having at least one time measuring unit, with the radio stations being configured to read and/or describe the times of the time measurement units of the radio transponders and with the radio stations being configured to synchronize the times of the time measurement units of the radio transponders and/or with the radio stations being configured to compare the times of the time measurement units of the radio transponders with the times of the time measurement units of the radio stations.

25. The safety system in accordance with claim 1, wherein the safety system has optical sensors, radar sensors, RFID sensors, and/or ultrasound sensors for localizing and detecting the objects.

26. The safety system in accordance with claim 1, wherein the radio location system is an ultra wideband radio location system, with the frequency used being in the range from 3.1 GHz to 10.6 GHz, with the transmission energy per radio station amounting to a maximum of 0.5 mW.

27. The safety system in accordance with claim 1, wherein a change of the safety function of the safety system takes place on the basis of the checked position data by means of the control and evaluation unit.

28. The safety system in accordance with claim 1, wherein position data checked by means of the control and evaluation unit controller are checked for agreement with stored position data of a safe point of interest.

29. A method using a safety system for localizing at least one object, the safety system having at least one control and evaluation unit, and having at least one radio location system,
wherein the radio location system has at least three arranged radio stations;
wherein at least one mobile device having at least one radio transponder is arranged at the object;
wherein position data of the radio transponder and thus position data of the objects are determined by means of the radio location system;
wherein the position data are transmitted from the radio station of the radio location system to the control and evaluation unit,
and/or wherein the position data are transmitted from the radio transponder to the control and evaluation unit,
wherein the control and evaluation unit is configured to cyclically detect the position data of the radio transponder,
with the objects being persons or mobile objects,
with the radio transponders having an identification, with a respective radio transponder being associated with at least either one person or one mobile object, with the control and evaluation unit being configured to distinguish the persons and mobile objects, and
with a spatially expanded protected volume being formed around the radio transponder.
